(19) United States
(12) Patent Application Publication
(10) Pub. No.: US 2026/0214545 A1
(43) Pub. Date: Jul. 23, 2026

(54) METHOD AND APPARATUS FOR EFFICIENT DISTRIBUTION IN DIGITAL DAS SYSTEMS

(71) Applicant: Outdoor Wireless Networks LLC, Richardson, TX (US)

(72) Inventor: Harsha Hegde, Hawthorn Woods, IL (US)

(73) Assignee: Outdoor Wireless Networks LLC, Richardson, TX (US)

(21) Appl. No.: 19/139,173

(22) PCT Filed: Dec. 13, 2023
(86) PCT No.: PCT/US2023/083768

§ 371 Date: Jun. 13, 2025

Related U.S. Application Data
(60) Provisional application No. 63/387,666, filed on Dec. 15, 2022.

(51) Int. Cl. H04W 40/04; H04L 5/00; H04W 88/08

(52) U.S. Cl. CPC H04W 40/04; H04L 5/001; H04L 5/0094; H04W 88/085

(57) ABSTRACT

Embodiments are directed to configuring one or more nodes in a distributed antenna system (DAS) to route signals to different signal paths in the DAS based on operator information and/or band information identified from the signals. The operator information can include an operator identifier present in the signal such as a PC_ID in a header of an Open-Radio Access Network (O-RAN) or enhanced Common Public Radio Interface (eCPRI) data packet. The band information can include a band identifier present in the signal such as a SEQ_ID in a header of the O-RAN or eCPRI data packet.

### CROSS-REFERENCE TO RELATED APPLICATIONS

This application claims priority to U.S. Provisional Application No. 63/387,666, filed on Dec. 15, 2022, and titled “METHOD AND APPARATUS FOR EFFICIENT DISTRIBUTION IN DIGITAL DAS SYSTEMS”, the contents of which are incorporated herein in their entirety.

### BACKGROUND

A distributed antenna system (DAS) typically includes one or more master units that are communicatively coupled to a plurality of remotely located access points or antenna units (also referred to here as “radio units”), where each access point can be coupled directly to one or more of the master units or indirectly via one or more other remote units and/or via one or more intermediary or expansion units or nodes. A DAS is typically used to improve the coverage provided by one or more base stations that are coupled to the central access nodes. These base stations can be coupled to the one or more master units via one or more cables or via a wireless connection, for example, using one or more donor antennas. The wireless service provided by the base stations can include commercial cellular service and/or private or public safety wireless communications.

A DAS can be conventionally embodied as an analog DAS, in which the master units communicate signals to and from the base stations in analog format, or as a digital DAS, in which the master units communicate signals to and from the base stations in a digital format. For example, the master units may receive digital downlink signals from a base station via a digital interface format such as Common Public Radio Interface (CPRI), Open Radio Equipment Interface (ORI), and Open Radio Access Network (O-RAN). In a 5G telecommunications network, digital signals may need to be distributed via a digital DAS to overcome coverage or capacity constraints. Furthermore, these digital signals may need to be distributed for multiple operators and multiple bands within the DAS. However, the coverage needs and constraints may not be the same for different operators and for different bands. As a conventional DAS architecture provides no way to control digital signal distribution based on operators and bands, a conventional DAS may not distribute wireless service coverage with multiple operators in an effective manner.

### SUMMARY

The details of one or more embodiments are set forth in the description below. The features illustrated or described in connection with one exemplary embodiment may be combined with the features of other embodiments. Thus, any of the various embodiments described herein can be combined to provide further embodiments. Aspects of the embodiments can be modified, if necessary to employ concepts of the various patents, applications and publications as identified herein to provide yet further embodiments.

In one embodiment, a method for distributing signal coverage in a distributed antenna system (DAS) is disclosed. The DAS includes at least one master unit communicatively coupled to a plurality of radio units. The plurality of radio units is configured to radiate wireless signals to user equipment. The method comprises receiving a first signal from at least one base station entity. The method comprises determining first operator information corresponding to a first operator of a plurality of operators from the first signal and/or first band information corresponding to a first band of a plurality of bands from the first signal. The method comprises routing the first signal to a first radio unit of the plurality of radio units based on the determined first operator information and/or the determined first band information from the first signal.

In another embodiment, a node of a distributed antenna system (DAS) is disclosed. The DAS includes at least one master unit communicatively coupled to a plurality of radio units. The plurality of radio units is configured to radiate wireless signals to user equipment. The node comprises downlink circuitry, wherein the downlink circuitry is configured to receive a first downlink signal transmitted or derived from at least one base station entity. The downlink circuitry is configured to determine first operator information corresponding to a first operator of a plurality of operators from the first downlink signal and/or first band information corresponding to a first band of a plurality of bands from the first downlink signal. The downlink circuitry is configured to route the first downlink signal to at least one other node of the distributed antenna system based on the determined first operator information and/or the determined first band information from the first downlink signal.

In yet another embodiment, a system is disclosed. The system comprises a distributed antenna system (DAS). The DAS comprises at least one master unit communicatively coupled to at least one base station entity. The at least one master unit is configured to receive downlink signals from the at least one base station entity. The DAS comprises a plurality of radio units communicatively coupled to the at least one master unit. Each of the plurality of radio units is configured to radiate downlink radio frequency (RF) signals based on the downlink signals to user equipment serviced by the distributed antenna system. The system comprises a system controller communicatively coupled to the at least one master unit of the DAS. The system controller is configured to determine a plurality of operator information and/or a plurality of band information, each respective operator information corresponding to one of a plurality of operators utilizing the distributed antenna system, each respective band information corresponding to one of a plurality of bands. The system controller is configured to determine, for each respective operator of the plurality of operators and/or each respective band of the plurality of bands, a respective signal distribution path of the DAS. The system controller is configured to configure one or more nodes in the DAS to route a received signal having the respective operator information and/or band information according to the respective signal distribution path determined for the respective operator and/or respective band.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, as briefly described below and as further described in the detailed description.

FIGS. 1-4 depict block diagrams illustrating exemplary systems configured for providing wireless service to user equipment.

FIG. 5 depicts a block diagram illustrating an exemplary system configured for routing DAS signals to one or more nodes of the DAS.

FIG. 6 depicts an exemplary representation of a digital signal transmitted to one or more nodes in a DAS.

FIGS. 7A-7B depict flow diagrams illustrating exemplary methods for routing downlink DAS signals to one or more nodes of the DAS.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the methods presented in the drawing figures and the specification are not to be construed as limiting the order in which the individual steps may be performed. The following detailed description is, therefore, not to be taken in a limiting sense.

The embodiments described below provide selective distribution of signals to one or more nodes in a distributed antenna system based on unique operator and/or band information present in a given signal. In various examples, a signal is selectively routed to one or more nodes based on information identifying the operator associated with the signal, the band associated with the signal, or both. A master unit, intermediate combining node (ICN), or other intermediary node of the DAS can determine an operator identifier such as a PC_ID in a header of a data packet, and route the signal to one of a plurality of output ports that correspond to the PC_ID in a header of the signal. Additionally, or alternatively, a master unit, ICN, or other intermediary node of the DAS can determine a band identifier such as a SEQ_ID in a header of a data packet, and route the signal to one of a plurality of output ports that correspond to the SEQ_ID in a header of the signal. A system controller or other management system can configure the nodes of the DAS to route a signal to a particular radio unit according to a distribution path determined for the operator and/or band that corresponds to the operator identifier and/or band identifier for that signal. Doing so enables discriminative routing of signals to different end points in the DAS depending on the particular operator and/or band associated with the signals.

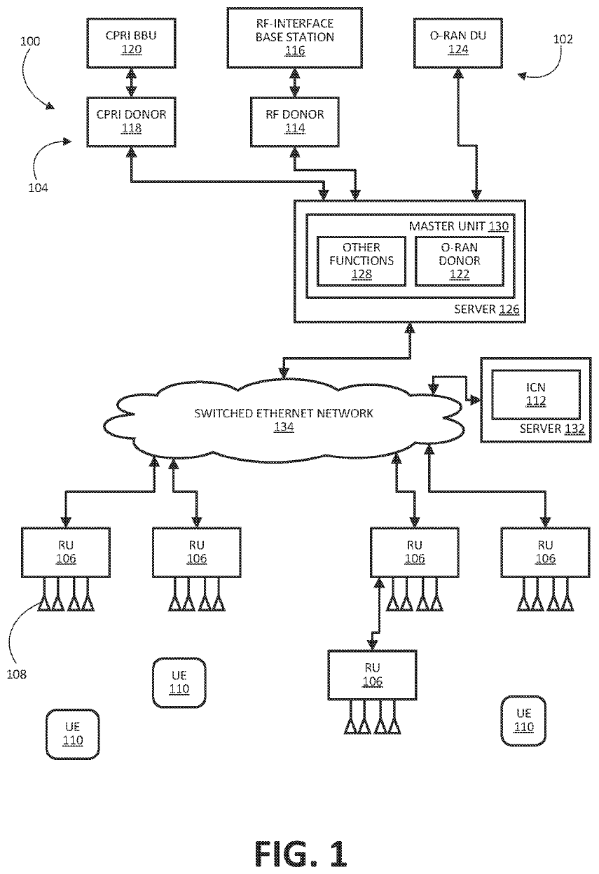

FIG. 1 is a block diagram illustrating an exemplary embodiment of a distributed antenna system (DAS) 100 that is configured to serve one or more base stations 102. In the exemplary embodiment shown in FIG. 1, the DAS 100 includes one or more donor units 104 that are used to couple the DAS 100 to the base stations 102. The DAS 100 also includes a plurality of remotely located radio units (RUs) 106 (also referred to as “antenna units,” “access points,” “remote units,” or “remote antenna units”). The RUs 106 are communicatively coupled to the donor units 104.

Each RU 106 includes, or is otherwise associated with, a respective set of coverage antennas 108 via which downlink analog RF signals can be radiated to user equipment (UEs) 110 and via which uplink analog RF signals transmitted by UEs 110 can be received. The DAS 100 is configured to serve each base station 102 using a respective subset of RUs 106 (which may include less than all of the RUs 106 of the DAS 100). Also, the subsets of RUs 106 used to serve the base stations 102 may differ from base station 102 to base station 102. The subset of RUs points 106 used to serve a given base station 102 is also referred to here as the “simulcast zone” for that base station 102. In general, the wireless coverage of a base station 102 served by the DAS 100 is improved by radiating a set of downlink RF signals for that base station 102 from the coverage antennas 108 associated with the multiple RUs 106 in that base station's stations simulcast zone and by producing a single “combined” set of uplink base station signals or data that is provided to that base station 102. The single combined set of uplink base station signals or data is produced by a combining or summing process that uses inputs derived from the uplink RF signals received via the coverage antennas 108 associated with the RUs 106 in that base station's simulcast zone.

The DAS 100 can also include one or more intermediary combining nodes (ICNs) 112 (also referred to as “expansion” units or nodes). For each base station 102 served by a given ICN 112, the ICN 112 is configured to receive a set of uplink transport data for that base station 102 from a group of “southbound” entities (that is, from RUs 106 and/or other ICNs 112) and generate a single set of combined uplink transport data for that base station 102, which the ICN 112 transmits “northbound” towards the donor unit 104 serving that base station 102. The single set of combined uplink transport data for each served base station 102 is produced by a combining or summing process that uses inputs derived from the uplink RF signals received via the coverage antennas 108 of any southbound RUs 106 included in that base station's simulcast zone. As used here, “southbound” refers to traveling in a direction “away,” or being relatively “farther,” from the donor units 104 and base stations 102, and “northbound” refers to traveling in a direction “towards”, or being relatively “closer” to, the donor units 104 and base stations 102.

In some configurations, each ICN 112 also forwards downlink transport data to the group of southbound RUs 106 and/or ICNs 112 served by that ICN 112. Generally, ICNs 112 can be used to increase the number of RUs 106 that can be served by the donor units 104 while reducing the processing and bandwidth load relative to having the additional RUs 106 communicate directly with each such donor unit 104.

Also, one or more RUs 106 can be configured in a “daisy-chain” or “ring” configuration in which transport data for at least some of those RUs 106 is communicated via at least one other RU 106. Each RU 106 would also perform the combining or summing process for any base station 102 that is served by that RU 106 and one or more of the southbound entities subtended from that RU 106. (Such a RU 106 also forwards northbound all other uplink transport data received from its southbound entities.)

The DAS 100 can include various types of donor units 104. One example of a donor unit 104 is an RF donor unit 114 that is configured to couple the DAS 100 to a base station 116 using the external analog radio frequency (RF) interface of the base station 116 that would otherwise be used to couple the base station 116 to one or more antennas (if the DAS 100 were not being used). This type of base station 116 is also referred to here as an “RF-interface” base station 116. An RF-interface base station 116 can be coupled to a corresponding RF donor unit 114 by coupling each antenna port of the base station 116 to a corresponding port of the RF donor unit 114.

Each RF donor unit 114 serves as an interface between each served RF-interface base station 116 and the rest of the DAS 100 and receives downlink base station signals from, and outputs uplink base station signals to, each served RF-interface base station 116. Each RF donor unit 114 performs at least some of the conversion processing necessary to convert the base station signals to and from the digital fronthaul interface format natively used in the DAS 100 for communicating time-domain baseband data. The downlink and uplink base station signals communicated between the RF-interface base station 116 and the donor unit 114 are analog RF signals. Also, in this example, the digital fronthaul interface format natively used in the DAS 100 for communicating time-domain baseband data can comprise the O-RAN fronthaul interface, a CPRI or enhanced CPRI (eCPRI) digital fronthaul interface format, or a proprietary digital fronthaul interface format (though other digital fronthaul interface formats can also be used).

Another example of a donor unit 104 is a digital donor unit that is configured to communicatively couple the DAS 100 to a baseband entity using a digital baseband fronthaul interface that would otherwise be used to couple the baseband entity to a radio unit (if the DAS 100 were not being used). In the example shown in FIG. 1, two types of digital donor units are shown.

The first type of digital donor unit comprises a digital donor unit 118 that is configured to communicatively couple the DAS 100 to a baseband unit (BBU) 120 using a time-domain baseband fronthaul interface implemented in accordance with a Common Public Radio Interface (“CPRI”) specification. This type of digital donor unit 118 is also referred to here as a “CPRI” donor unit 118, and this type of BBU 120 is also referred to here as a CPRI BBU 120. For each CPRI BBU 120 served by a CPRI donor unit 118, the CPRI donor unit 118 is coupled to the CPRI BBU 120 using the CPRI digital baseband fronthaul interface that would otherwise be used to couple the CPRI BBU 120 to a CPRI remote radio head (RRH) (if the DAS 100 were not being used). A CPRI BBU 120 can be coupled to a corresponding CPRI donor unit 118 via a direct CPRI connection.

Each CPRI donor unit 118 serves as an interface between each served CPRI BBU 120 and the rest of the DAS 100 and receives downlink base station signals from, and outputs uplink base station signals to, each CPRI BBU 120. Each CPRI donor unit 118 performs at least some of the conversion processing necessary to convert the CPRI base station data to and from the digital fronthaul interface format natively used in the DAS 100 for communicating time-domain baseband data. The downlink and uplink base station signals communicated between each CPRI BBU 120 and the CPRI donor unit 118 comprise downlink and uplink fronthaul data generated and formatted in accordance with the CPRI baseband fronthaul interface.

The second type of digital donor unit comprises a digital donor unit 122 that is configured to communicatively couple the DAS 100 to a BBU 124 using a frequency-domain baseband fronthaul interface implemented in accordance with a O-RAN Alliance specification. The acronym “O-RAN” is an abbreviation for “Open Radio Access Network.” This type of digital donor unit 122 is also referred to here as an “O-RAN” donor unit 122, and this type of BBU 124 is typically an O-RAN distributed unit (DU) and is also referred to here as an O-RAN DU 124. For each O-RAN DU 124 served by a O-RAN donor unit 122, the O-RAN donor unit 122 is coupled to the O-DU 124 using the O-RAN digital baseband fronthaul interface that would otherwise be used to couple the O-RAN DU 124 to a O-RAN RU (if the DAS 100 were not being used). An O-RAN DU 124 can be coupled to a corresponding O-RAN donor unit 122 via a switched Ethernet network. Alternatively, an O-RAN DU 124 can be coupled to a corresponding O-RAN donor unit 122 via a direct Ethernet or CPRI connection.

Each O-RAN donor unit 122 serves as an interface between each served O-RAN DU 124 and the rest of the DAS 100 and receives downlink base station signals from, and outputs uplink base station signals to, each O-RAN DU 124. Each O-RAN donor unit 122 performs at least some of any conversion processing necessary to convert the base station signals to and from the digital fronthaul interface format natively used in the DAS 100 for communicating frequency-domain baseband data. The downlink and uplink base station signals communicated between each O-RAN DU 124 and the O-RAN donor unit 122 comprise downlink and uplink fronthaul data generated and formatted in accordance with the O-RAN baseband fronthaul interface, where the user-plane data comprises frequency-domain baseband IQ data. Also, in this example, the digital fronthaul interface format natively used in the DAS 100 for communicating O-RAN fronthaul data is the same O-RAN fronthaul interface used for communicating base station signals between each O-RAN DU 124 and the O-RAN donor unit 122, and the “conversion” performed by each O-RAN donor unit 122 (and/or one or more other entities of the DAS 100) includes performing any needed “multicasting” of the downlink data received from each O-RAN DU 124 to the multiple RUs 106 in a simulcast zone for that O-RAN DU 124 (for example, by communicating the downlink fronthaul data to an appropriate multicast address and/or by copying the downlink fronthaul data for communication over different fronthaul links) and performing any need combining or summing of the uplink data received from the RUs 106 to produce combined uplink data provided to the O-RAN DU 124. It is to be understood that other digital fronthaul interface formats can also be used.

In general, the various base stations 102 are configured to communicate with a core network (not shown) of the associated wireless operator using an appropriate backhaul network (typically, a public wide area network such as the Internet). Also, the various base stations 102 may be from multiple, different wireless operators and/or the various base stations 102 may support multiple, different wireless protocols and/or RF bands.

In general, for each base station 102, the DAS 100 is configured to receive a set of one or more downlink base station signals from the base station 102 (via an appropriate donor unit 104), generate downlink transport data derived from the set of downlink base station signals, and transmit the downlink transport data to the RUs 106 in the base station's simulcast zone. For each base station 102 served by a given RU 106, the RU 106 is configured to receive the downlink transport data transmitted to it via the DAS 100 and use the received downlink transport data to generate one or more downlink analog radio frequency signals that are radiated from one or more coverage antennas 108 associated with that RU 106 for reception by user equipment 110. In this way, the DAS 100 increases the coverage area for the downlink capacity provided by the base stations 102. Also, for any southbound entities (for example, southbound RUs 106 or ICNs 112) coupled to the RU 106 (for example, in a daisy chain or ring architecture), the RU 106 forwards any downlink transport data intended for those southbound entities towards them.

For each base station 102 served by a given RU 106, the RU 106 is configured to receive one or more uplink radio frequency signals transmitted from the user equipment 110. These signals are analog radio frequency signals and are received via the coverage antennas 108 associated with that RU 106. The RU 106 is configured to generate uplink transport data derived from the one or more remote uplink radio frequency signals received for the served base station 102 and transmit the uplink transport data northbound towards the donor unit 104 coupled to that base station 102.

For each base station 102 served by the DAS 100, a single “combined” set of uplink base station signals or data is produced by a combining or summing process that uses inputs derived from the uplink RF signals received via the RUs 106 in that base station's simulcast zone. The resulting final single combined set of uplink base station signals or data is provided to the base station 102. This combining or summing process can be performed in a centralized manner in which the combining or summing process is performed by a single unit of the DAS 100 (for example, a donor unit 104 or master unit 130). This combining or summing process can also be performed in a distributed or hierarchical manner in which the combining or summing process is performed by multiple units of the DAS 100 (for example, a donor unit 104 (or master unit 130) and one or more ICNs 112 and/or RUs 106). Each unit of the DAS 100 that performs the combining or summing process for a given base station 102 receives uplink transport data from that unit's southbound entities and uses that data to generate combined uplink transport data, which the unit transmits northbound towards the base station 102. The generation of the combined uplink transport data involves, among other things, extracting in-phase and quadrature (IQ) data from the received uplink transport data and performing a combining or summing process using any uplink IQ data for that base station 102 in order to produce combined uplink IQ data.

Some of the details regarding how base station signals or data are communicated and transport data is produced vary based on which type of base station 102 is being served. In the case of an RF-interface base station 116, the associated RF donor unit 114 receives analog downlink RF signals from the RF-interface base station 116 and, either alone or in combination with one or more other units of the DAS 100, converts the received analog downlink RF signals to the digital fronthaul interface format natively used in the DAS 100 for communicating time-domain baseband data (for example, by digitizing, digitally down-converting, and filtering the received analog downlink RF signals in order to produce digital baseband IQ data and formatting the resulting digital baseband IQ data into packets) and communicates the resulting packets of downlink transport data to the various RUs 106 in the simulcast zone of that base station 116. The RUs 106 in the simulcast zone for that base station 116 receive the downlink transport data and use it to generate and radiate downlink RF signals as described above. In the uplink, either alone or in combination with one or more other units of the DAS 100, the RF donor unit 114 generates a set of uplink base station signals from uplink transport data received by the RF donor unit 114 (and/or the other units of the DAS 100 involved in this process). The set of uplink base station signals is provided to the served base station 116. The uplink transport data is derived from the uplink RF signals received at the RUs 106 in the simulcast zone of the served base station 116 and communicated in packets.

In the case of a CPRI BBU 120, the associated CPRI digital donor unit 118 receives CPRI downlink fronthaul data from the CPRI BBU 120 and, either alone or in combination with another unit of the DAS 100, converts the received CPRI downlink fronthaul data to the digital fronthaul interface format natively used in the DAS 100 for communicating time-domain baseband data (for example, by re-sampling, synchronizing, combining, separating, gain adjusting, etc. the CPRI baseband IQ data, and formatting the resulting baseband IQ data into packets), and communicates the resulting packets of downlink transport data to the various RUs 106 in the simulcast zone of that CPRI BBU 120. The RUs 106 in the simulcast zone of that CPRI BBU 120 receive the packets of downlink transport data and use them to generate and radiate downlink RF signals as described above. In the uplink, either alone or in combination with one or more other units of the DAS 100, the CPRI donor unit 118 generates uplink base station data from uplink transport data received by the CPRI donor unit 118 (and/or the other units of the DAS 100 involved in this process). The resulting uplink base station data is provided to that CPRI BBU 120. The uplink transport data is derived from the uplink RF signals received at the RUs 106 in the simulcast zone of the CPRI BBU 120.

In the case of an O-RAN DU 124, the associated O-RAN donor unit 122 receives packets of O-RAN downlink fronthaul data (that is, O-RAN user-plane and control-plane messages) from each O-RAN DU 124 coupled to that O-RAN digital donor unit 122 and, either alone or in combination with another unit of the DAS 100, converts (if necessary) the received packets of O-RAN downlink fronthaul data to the digital fronthaul interface format natively used in the DAS 100 for communicating O-RAN baseband data and communicates the resulting packets of downlink transport data to the various RUs 106 in a simulcast zone for that ORAN DU 124. The RUs 106 in the simulcast zone of each O-RAN DU 124 receive the packets of downlink transport data and use them to generate and radiate downlink RF signals as described above. In the uplink, either alone or in combination with one or more other units of the DAS 100, the O-RAN donor unit 122 generates packets of uplink base station data from uplink transport data received by the O-RAN donor unit 122 (and/or the other units of the DAS 100 involved in this process). The resulting packets of uplink base station data are provided to the O-RAN DU 124. The uplink transport data is derived from the uplink RF signals received at the RUs 106 in the simulcast zone of the served O-RAN DU 124 and communicated in packets.

In one implementation, one of the units of the DAS 100 is also used to implement a “master” timing entity for the DAS 100 (for example, such a master timing entity can be implemented as a part of a master unit 130 described below). In another example, a separate, dedicated timing master entity (not shown) is provided within the DAS 100. In either case, the master timing entity synchronizes itself to an external timing master entity (for example, a timing master associated with one or more of the O-DUs 124) and, in turn, that entity serves as a timing master entity for the other units of the DAS 100. A time synchronization protocol (for example, the Institute of Electrical and Electronics Engineers (IEEE) 1588 Precision Time Protocol (PTP), the Network Time Protocol (NTP), or the Synchronous Ethernet (SyncE) protocol) can be used to implement such time synchronization.

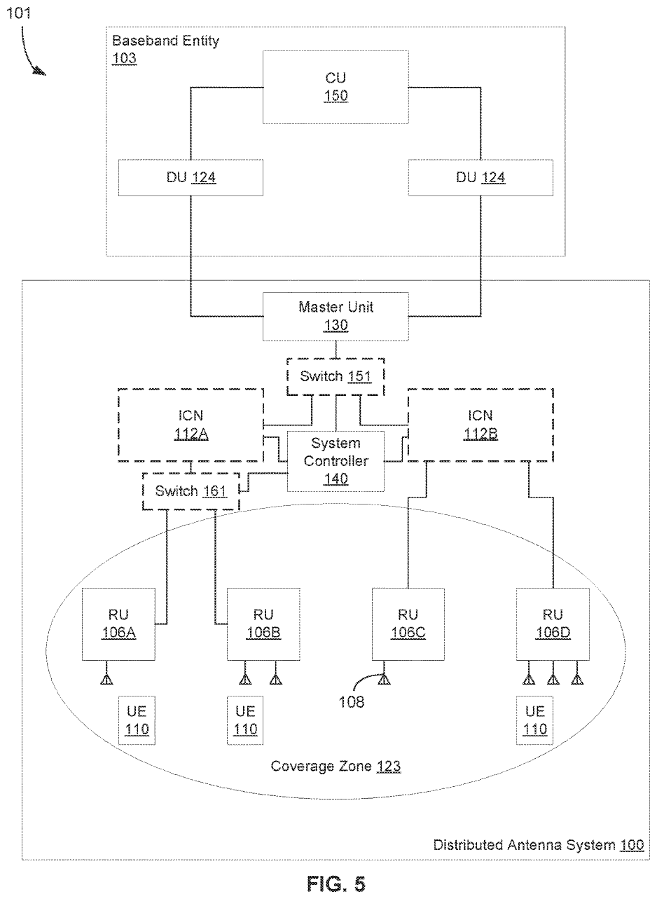

A management system (see e.g., system controller 140 of FIG. 5) can be used to manage the various nodes of the DAS 100. In one implementation, the management system communicates with a predetermined “master” entity for the DAS 100 (for example, the master unit 130 described below), which in turns forwards or otherwise communicates with the other units of the DAS 100 for management-plane purposes. In another implementation, the management system communicates with the various units of the DAS 100 directly for management-plane purposes (that is, without using a master entity as a gateway).

Each base station 102 (including each RF-interface base station 116, CPRI BBU 120, and O-RAN DU 124), donor unit 104 (including each RF donor unit 114, CPRI donor unit 118, and O-RAN donor unit 122), RU 106, ICN 112, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.). Such entities can be implemented in other ways.

The DAS 100 can be implemented in a virtualized manner or a non-virtualized manner. When implemented in a virtualized manner, one or more nodes, units, or functions of the DAS 100 are implemented using one or more virtual network functions (VNFs) executing on one or more physical server computers (also referred to here as “physical servers” or just “servers”) (for example, one or more commercial-off-the-shelf (COTS) servers of the type that are deployed in data centers or “clouds” maintained by enterprises, communication service providers, or cloud services providers). More specifically, in the exemplary embodiment shown in FIG. 1, each O-RAN donor unit 122 is implemented as a VNF running on a server 126. The server 126 can execute other VNFs 128 that implement other functions for the DAS 100 (for example, fronthaul, management plane, and synchronization plane functions). The various VNFs executing on the server 126 are also referred to here as “master unit” functions 130 or, collectively, as the “master unit” 130. Also, in the exemplary embodiment shown in FIG. 1, each ICN 112 is implemented as a VNF running on a server 132.

The RF donor units 114 and CPRI donor units 118 can be implemented as cards (for example, Peripheral Component Interconnect (PCI) Cards) that are inserted in the server 126. Alternatively, the RF donor units 114 and CPRI donor units 118 can be implemented as separate devices that are coupled to the server 126 via dedicated Ethernet links or via a switched Ethernet network (for example, the switched Ethernet network 134 described below).

In the exemplary embodiment shown in FIG. 1, the donor units 104, RUs 106 and ICNs 112 are communicatively coupled to one another via a switched Ethernet network 134. Also, in the exemplary embodiment shown in FIG. 1, an O-RAN DU 124 can be coupled to a corresponding O-RAN donor unit 122 via the same switched Ethernet network 134 used for communication within the DAS 100 (though each O-RAN DU 124 can be coupled to a corresponding O-RAN donor unit 122 in other ways). In the exemplary embodiment shown in FIG. 1, the downlink and uplink transport data communicated between the units of the DAS 100 is formatted as O-RAN data that is communicated in Ethernet packets over the switched Ethernet network 134. In the exemplary embodiment shown in FIG. 1, the RF donor units 114 and CPRI donor units 118 are coupled to the RUs 106 and ICNs 112 via the master unit 130.

In the downlink, the RF donor units 114 and CPRI donor units 118 provide downlink time-domain baseband IQ data to the master unit 130. The master unit 130 generates downlink O-RAN user-plane messages containing downlink baseband IQ that is either the time-domain baseband IQ data provided from the donor units 114 and 118 or is derived therefrom (for example, where the master unit 130 converts the received time-domain baseband IQ data into frequency-domain baseband IQ data). The master unit 130 also generates corresponding downlink O-RAN control-plane messages for those O-RAN user-plane messages. The resulting downlink O-RAN user-plane and control-plane messages are communicated (multicasted) to the RUs 106 in the simulcast zone of the corresponding base station 102 via the switched Ethernet network 134.

In the uplink, for each RF-interface base station 116 and CPRI BBU 120, the master unit 130 receives O-RAN uplink user-plane messages for the base station 116 or CPRI BBU 120 and performs a combining or summing process using the uplink baseband IQ data contained in those messages in order to produce combined uplink baseband IQ data, which is provided to the appropriate RF donor unit 114 or CPRI donor unit 118. The RF donor unit 114 or CPRI donor unit 118 uses the combined uplink baseband IQ data to generate a set of base station signals or CPRI data that is communicated to the corresponding RF-interface base station 116 or CPRI BBU 120. If time-domain baseband IQ data has been converted into frequency-domain baseband IQ data for transport over the DAS 100, the donor unit 114 or 118 also converts the combined uplink frequency-domain IQ data into combined uplink time-domain IQ data as part of generating the set of base station signals or CPRI data that is communicated to the corresponding RF-interface base station 116 or CPRI BBU 120.

In the exemplary embodiment shown in FIG. 1, the master unit 130 (more specifically, the O-RAN donor unit 122) receives downlink O-RAN user-plane and control-plane messages from each served O-RAN DU 124 and communicates (multicasts) them to the RUs 106 in the simulcast zone of the corresponding O-RAN DU 124 via the switched Ethernet network 134. In the uplink, the master unit 130 (more specifically, the O-RAN donor unit 122) receives O-RAN uplink user-plane messages for each served O-RAN DU 124 and performs a combining or summing process using the uplink baseband IQ data contained in those messages in order to produce combined uplink IQ data. The O-RAN donor unit 122 produces O-RAN uplink user-plane messages containing the combined uplink baseband IQ data and communicates those messages to the O-RAN DU 124.

In the exemplary embodiment shown in FIG. 1, only uplink transport data is communicated using the ICNs 112, and downlink transport data is communicated from the master unit 130 to the RUs 106 without being forwarded by, or otherwise communicated using, the ICNs 112.

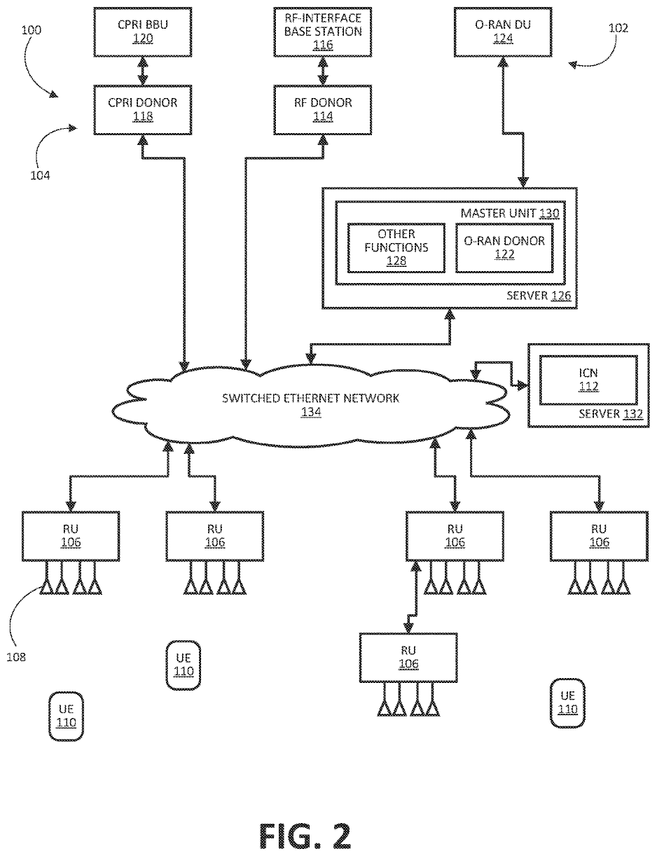

FIG. 2 illustrates another exemplary embodiment of a DAS 100. The DAS 100 shown in FIG. 2 is the same as the DAS 100 shown in FIG. 1 except as described below. In the exemplary embodiment shown in FIG. 2, the RF donor units 114 and CPRI donor units 118 are coupled directly to the switched Ethernet network 134 and not via the master unit 130, as is the case in the embodiment shown in FIG. 1.

As described above, in the exemplary embodiment shown in FIG. 1, the master unit 130 performs some transport functions related to serving the RF-interface base stations 116 and CPRI BBUs 120 coupled to the donor units 114 and 118. In the exemplary embodiment shown in FIG. 2, the RF donor units 114 and CPRI donor units 118 perform those transport functions (that is, the RF donor units 114 and CPRI donor units 118 perform all of the transport functions related to serving the RF-interface base stations 116 and CPRI BBUs 120, respectively).

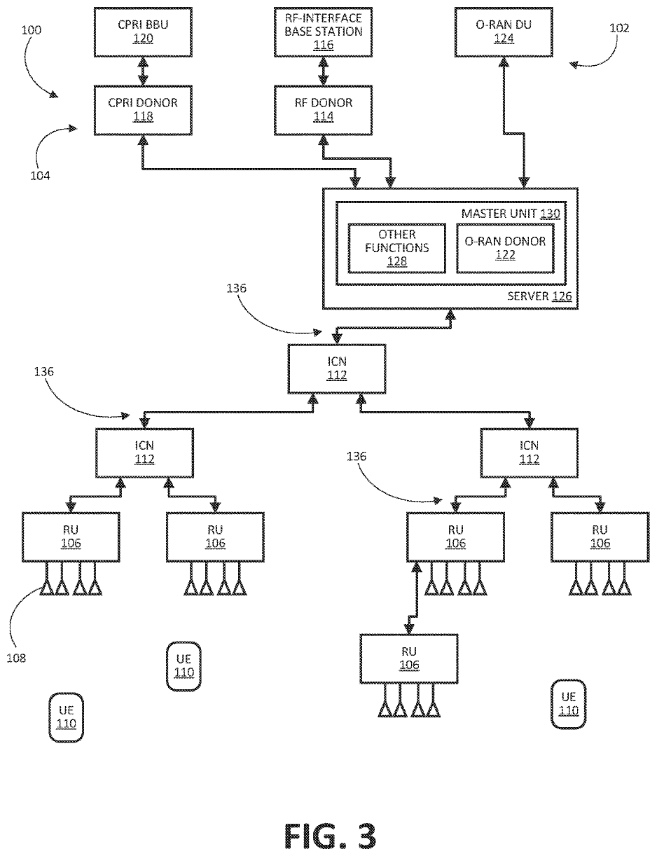

FIG. 3 illustrates another exemplary embodiment of a DAS 100. The DAS 100 shown in FIG. 3 is the same as the DAS 100 shown in FIG. 1 except as described below. In the exemplary embodiment shown in FIG. 3, the donor units 104, RUs 106 and ICNs 112 are communicatively coupled to one another via point-to-point Ethernet links 136 (instead of a switched Ethernet network). Also, in the exemplary embodiment shown in FIG. 3, an O-RAN DU 124 can be coupled to a corresponding O-RAN donor unit 122 via a switched Ethernet network (not shown in FIG. 3), though that switched Ethernet network is not used for communication within the DAS 100. In the exemplary embodiment shown in FIG. 3, the downlink and uplink transport data communicated between the units of the DAS 100 is communicated in Ethernet packets over the point-to-point Ethernet links 136.

For each southbound point-to-point Ethernet link 136 that couples a master unit 130 to an ICN 112, the master unit 130 assembles downlink transport frames and communicates them in downlink Ethernet packets to the ICN 112 over the point-to-point Ethernet link 136. For each point-to-point Ethernet link 136, each downlink transport frame multiplexes together downlink time-domain baseband IQ data and Ethernet data that needs to be communicated to southbound RUs 106 and ICNs 112 that are coupled to the master unit 130 via that point-to-point Ethernet link 136. The downlink time-domain baseband IQ data is sourced from one or more RF donor units 114 and/or CPRI donor units 118. The Ethernet data comprises downlink user-plane and control-plane O-RAN fronthaul data sourced from one or more O-RAN donor units 122 and/or management-plane data sourced from one or more management entities for the DAS 100. That is, this Ethernet data is encapsulated into downlink transport frames that are also used to communicate downlink time-domain baseband IQ data and this Ethernet data is also referred to here as “encapsulated” Ethernet data. The resulting downlink transport frames are communicated in the payload of downlink Ethernet packets communicated from the master unit 130 to the ICN 112 over the point-to-point Ethernet link 136. The Ethernet packets into which the encapsulated Ethernet data is encapsulated are also referred to here as “transport” Ethernet packets.

Each ICN 112 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. Any encapsulated Ethernet data that is intended for the ICN 112 (for example, management-plane Ethernet data) is processed by the ICN 112.

For each southbound point-to-point Ethernet link 136 coupled to the ICN 112, the ICN 112 assembles downlink transport frames and communicates them in downlink Ethernet packets to the southbound entities subtended from the ICN 112 via the point-to-point Ethernet link 136. For each southbound point-to-point Ethernet link 136, each downlink transport frame multiplexes together downlink time-domain baseband IQ data and Ethernet data received at the ICN 112 that needs to be communicated to those subtended southbound entities. The resulting downlink transport frames are communicated in the payload of downlink transport Ethernet packets communicated from the ICN 112 to those subtended southbound entities ICN 112 over the point-to-point Ethernet link 136.

Each RU 106 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. As described above, the RU 106 uses any downlink time-domain baseband IQ data and/or downlink O-RAN user-plane and control-plane fronthaul messages to generate downlink RF signals for radiation from the set of coverage antennas 108 associated with that RU 106. The RU 106 processes any management-plane messages communicated to that RU 106 via encapsulated Ethernet data.

Also, for any southbound point-to-point Ethernet link 136 coupled to the RU 106, the RU 106 assembles downlink transport frames and communicates them in downlink Ethernet packets to the southbound entities subtended from the RU 106 via the point-to-point Ethernet link 136. For each southbound point-to-point Ethernet link 136, each downlink transport frame multiplexes together downlink time-domain baseband IQ data and Ethernet data received at the RU 106 that needs to be communicated to those subtended southbound entities. The resulting downlink transport frames are communicated in the payload of downlink transport Ethernet packets communicated from the RU 106 to those subtended southbound entities ICN 112 over the point-to-point Ethernet link 136.

In the uplink, each RU 106 generates uplink time-domain baseband IQ data and/or uplink O-RAN user-plane fronthaul messages for each RF-interface base station 116, CPRI BBU 120, and/or O-RAN DU 124 served by that RU 106 as described above. For each northbound point-to-point Ethernet link 136 of the RU 106, the RU 106 assembles uplink transport frames and communicates them in uplink transport Ethernet packets northbound towards the appropriate master unit 130 via that point-to-point Ethernet link 136. For each northbound point-to-point Ethernet link 136, each uplink transport frame multiplexes together uplink time-domain baseband IQ data originating from that RU 106 and/or any southbound entity subtended from that RU 106 as well as any Ethernet data originating from that RU 106 and/or any southbound entity subtended from that RU 106. In connection with doing this, the RU 106 performs the combining or summing process described above for any base station 102 served by that RU 106 and also by one or more of the subtended entities. (The RU 106 forwards northbound all other uplink data received from those southbound entities.) The resulting uplink transport frames are communicated in the payload of uplink transport Ethernet packets northbound towards the master unit 130 via the associated point-to-point Ethernet link 136.

Each ICN 112 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. For each northbound point-to-point Ethernet link 136 coupled to the ICN 112, the ICN 112 assembles uplink transport frames and communicates them in uplink transport Ethernet packets northbound towards the master unit 130 via that point-to-point Ethernet link 136. For each northbound point-to-point Ethernet link 136, each uplink transport frame multiplexes together uplink time-domain baseband IQ data and Ethernet data received at the ICN 112 that needs to be communicated northbound towards the master unit 130. In connection with doing this, the ICN 112 performs the combining or summing process described above for any base station 102 served by that ICN 112 for which it has received uplink baseband IQ data from multiple entities subtended from that ICN 112. The resulting uplink transport frames are communicated in the payload of uplink transport Ethernet packets communicated northbound towards the master unit 130 over the point-to-point Ethernet link 136.

Each master unit 130 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. Any extracted uplink time-domain baseband IQ data, as well as any uplink O-RAN messages communicated in encapsulated Ethernet, is used in producing a single “combined” set of uplink base station signals or data for the associated base station 102 as described above (which includes performing the combining or summing process). Any other encapsulated Ethernet data (for example, management-plane Ethernet data) is forwarded on towards the respective destination (for example, a management entity).

In the exemplary embodiment shown in FIG. 3, synchronization-plane messages are communicated using native Ethernet packets (that is, non-encapsulated Ethernet packets) that are interleaved between the transport Ethernet packets.

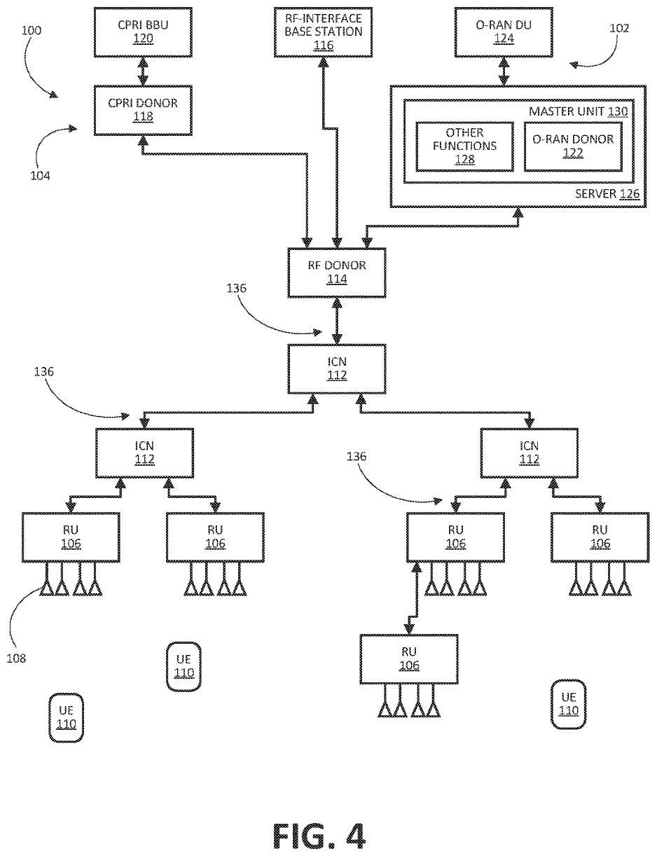

FIG. 4 illustrates another exemplary embodiment of a DAS 100. The DAS 100 shown in FIG. 4 is the same as the DAS 100 shown in FIG. 3 except as described below. In the exemplary embodiment shown in FIG. 4, the CPRI donor units 118, O-RAN donor unit 122, and master unit 130 are coupled to the RUs 106 and ICNs 112 via one or more RF units 114. That is, each RF unit 114 performs the transport frame multiplexing and demultiplexing that is described above in connection with FIG. 3 as being performed by the master unit 130.

FIG. 5 depicts a block diagram illustrating an exemplary system 101 configured for providing wireless service to user equipment in a coverage zone. System 101 includes a baseband entity 103 communicatively coupled to a DAS 100. In the example shown in FIG. 5, the baseband entity 103 includes a central unit (CU) 150 coupled to a plurality of distributed units (DUs) 124. The DAS 100 includes one or more radio units (RUs) 106A-106D located downstream of the DUs 124. In some examples, system 101 is configured so that each DU 124 is configured to serve one or more RUs 106A-106D. Although FIG. 5 and the description set forth more generally is described in the context of a fifth generation (5G) wireless system in which the logical baseband entity 103 is partitioned into a CU 150 and a DU 124, other configurations are possible. For example, system 101 can be implemented using a fourth generation (4G) Long Term Evolution (LTE) network interface or any other wireless interface. And while the RUs 106A-106D are shown as nodes of the DAS 100, the RUs 106A-106D may also form part of a logical base station entity that also includes the baseband entity 103, such as the CU 150 and the DUs 124. In some examples, at least some of the RUs 106A-106D are configured to perform some baseband processing (including but not limited to physical layer processing) that would conventionally be performed by the baseband entity 103. The base station entity can also be implemented in other configurations. As one example, the baseband entity 103 can be implemented as a conventional baseband unit (BBU) and one or more of the RUs 106A-106B can be implemented as a remote radio head (RRH). Accordingly, references to a CU, DU, or RU in this description and associated figures can also be considered to refer more generally to any entity (including, for example, any “base station” or radio access network (RAN) entity) implementing any of the functions or features described herein as being implemented by a CU, DU, or RU.

DAS 100 can also be implemented in various configurations. For example, DAS 100 can be implemented as a conventional digital DAS in which one or more nodes of the DAS (including master unit 130, ICNs 112A-112B, and RUs 106A-106D) are implemented as discrete units that are located remotely from each other and comprise circuitry for processing and transmitting digital signals from baseband entity 103 within the DAS 100, as further described herein. As another example, one or more nodes of the DAS 100 (including master unit 130 and ICNs 112A-112B) can be implemented as a virtual node whose functionality is executed by one or more processors. In this example configuration, DAS 100 operates as a virtual DAS (vDAS) with one or more virtual network functions (VNFs) performing the functions of the DAS 100.

Other configurations of system 101 can be used. In another configuration, the baseband entity 103 (including CU 150 and DUs 124) is implemented using a scalable cloud environment in which resources used to instantiate each type of entity can be scaled horizontally (that is, by increasing or decreasing the number of physical computers or other physical devices) and vertically, that is, by increasing or decreasing the “power” (for example, by increasing the amount of processing and/or memory resources) of a given physical computer or other physical device). The scalable cloud environment can be implemented in various ways. For example, the scalable-cloud environment can be implemented using hardware virtualization, operating system virtualization, and application virtualization (also referred to as containerization) as well as various combinations of two or more of the preceding. The scalable cloud environment can be implemented in other ways. For example, the scalable-cloud environment is implemented in a distributed manner. That is, the scalable-cloud environment is implemented as a distributed scalable-cloud environment comprising at least one central cloud, at least one edge cloud, and at least one radio cloud.

In some examples, the DU 124 is implemented as a software virtualized entity that is executed in a scalable-cloud environment on a cloud worker node under the control of the cloud native software executing on that cloud worker node. In such examples, the DU 124 is communicatively coupled to at least one CU control plane (CU-CP) entity and at least one CU user plane (CU-UP) entity, which can also be implemented as software virtualized entities, and are omitted from FIG. 5 for clarity.

In some examples, the DU 124 is implemented as a single virtualized entity executing on a single cloud worker node. The at least one CU-CP and the at least one CU-UP can each be implemented as a single virtualized entity executing on the same cloud worker node or as a single virtualized entity executing on a different cloud worker node. However, other configurations are possible. In another example, the CU 150 can be implemented using multiple CU-UP VNFs and using multiple virtualized entities executing on one or more cloud worker nodes. As another example, multiple DUs 124 (using multiple virtualized entities executing on one or more cloud worker nodes) can be used to serve a cell, where each of the multiple DUs 124 serves a different set of RUs 106A-106D. The CU 150 and DUs 124 can also be implemented in the same cloud (for example, together in the radio cloud or in an edge cloud). Other configurations and examples can be implemented.

Now referring generally to the DAS 100, which is configured to be coupled to one or more base station entities (including baseband entity 103) in order to improve the coverage provided by the base station entities. That is, each base station entity is configured to provide wireless capacity, whereas the DAS 100 is configured to provide improved wireless coverage for the wireless capacity provided by the base station entity.

DAS 100 is communicatively coupled to a system controller 140. The system controller 140 is communicatively coupled to MU 130 and/or to the ICNs 112A-112B, for example, by wireless or wired communication links. For example, system controller 140 may be coupled to MU 130 via optional switch 151, or though not explicitly shown in FIG. 5, can be coupled to MU 130 directly (e.g., if switch 151 is not implemented). In some examples, system controller 140 is coupled to optional switch 161. System controller 140 is generally configured to route the distribution of signals to different signal pathways, and hence to different nodes, in the DAS 100 based on data extracted from the signals received from baseband entity 103. In some examples, system controller 140 is implemented as a discrete processing unit, whereas in other examples, system controller 140 is virtualized and implemented as a VNF that coordinates management plane (M-Plane) data between the MU 130, ICNs 112A-112B, and RUs 106A-106D. If ICN 112B is not implemented, then the RUs 106C-106D can be coupled to MU 130 via optional switch 151. If switch 151 and ICN 112B is not implemented, then RUs 106C-106D can be directly coupled to MU 130.

As previously noted, DAS 100 is configured to extend wireless coverage for multiple service providers (referred to herein as “operators”) transmitting across multiple frequency bands in the one or more coverage zones 123. When MU 130 receives a signal from baseband entity 103, the signal will include information regarding the operator and the bands that correspond to that signal. System controller 140 is configured to determine an identifier for each operator that transmits downlink signals in the DAS 100 and an identifier for each band in use in the DAS 100. For example, system controller 140 can access a database with stored identifiers with each operator and band in use. The identifiers for each operator and band can be updated as new operators utilize the DAS 100 for wireless service or as the bands change.

System controller 140 is further configured to determine a distribution path for each operator and for each band in use. In one example, the system controller 140 determines the distribution path for each operator and for each band prior to DAS 100 operation (e.g., before receiving user-plane and control-plane data from baseband entity 103, such as during startup). The distribution path is the signal pathway through the DAS 100 from the MU 130 to a particular ICN (ICN 112A, for example, if DAS 100 includes ICNs) and a particular RU (RU 106A, for example). A distribution path can be defined as a signal pathway from one or more input/output (I/O) ports of the MU 130 to another node of the DAS 100. For example, if MU 130 includes two output ports (one corresponding to a respective ICN 112A, 112B), a first distribution path would include the signal pathway between MU 130 and the ICN 112A, while a second distribution path would include the signal pathway between MU 130 and ICN 112B. If ICN 112A, for example, includes two output ports each connected to respective RU 106A, 106B (as shown in FIG. 5), then the first distribution path can be the signal pathway from MU 130, to ICN 112A, to RU 106A, while the second distribution path can be the signal pathway from MU 130 to ICN 112B, to RU 106D. Other combinations of nodes are possible, such as from MU 130, to ICN 112A, to RU 106B, each defining a different distribution path that be determined by the system controller 140.

Each operator can be associated with one or more distribution paths in the DAS 100. For example, system controller 140 can determine that the distribution path for signals transmitted by a first operator would be the signal pathway from MU 130 to ICN 112A, to RU 106B, whereas the distribution path for signals transmitted by a second operator would be the signal pathway from MU 130 to ICN 112B to RU 106C. In other examples, system controller 140 determines multiple distribution paths for a given operator. In these examples, a third operator can be associated with both the distribution path from MU 130 to ICN 112B to RU 106D and the distribution path from MU 130 to ICN 112A to RU 106B. Different bands can also be designated different distribution paths in the DAS 100. For example, system controller 140 may determine that the distribution path for a first band in use would be the distribution path from MU 130 to ICN 112A to RU 106A, which may be different for the distribution path associated with a second band and so on for each distinct band in use.

System controller 140 is configured to configure one or more nodes of DAS 100 (such as MU 130, ICNs 112A-112B, and/or switches 151, 161) for routing signals through distribution paths of the DAS 100 based on the operator information and/or band information extracted from the signals. For example, when system controller 140 determines a distribution path for a first operator, system controller 140 configures the MU 130 to route signals with an identifier that corresponds to the first operator according to the distribution path determined by the system controller 140. In some examples, system controller 140 can also configure the ICNs 112A-112B so that when signals corresponding to the first operator are received at the respective ICN, that ICN can forward the signals to the appropriate RU as defined by the distribution path for the first operator. System controller 140 is also configured to configure MU 130 and optionally ICNs 112A-112B to route signals based on the band identifier that corresponds to each distinct band. In some examples, system controller 140 configures the MU 130 and/or ICNs 112A-112B by setting (e.g., via control signals to the respective node) the output filters of each node so that the respective node (MU 130, for example) can route downlink signals that correspond to different operators and/or bands to different output ports. As used herein, “downlink signals” would encompass both the signals received from the baseband entity 103 as well as downlink transport signals or other derived signals (e.g., processing performed on the received signals by one or more nodes in the DAS 100) from the signals received from the baseband entity 103. In some examples, the downlink signals can include digital signals received from baseband entity 103 and/or digital signals processed in the DAS 100. The signals are further described in the context of digital signals understanding that other types of signals can be used.

In some examples, the identifier for a given operator is a PC_ID in a header of an O-RAN or eCPRI packet, and the identifier for a given band is a SEQ_ID in a header of an O-RAN or eCPRI packet. In these examples, system controller 140 configures MU 130 to route digital signals having a PC_ID associated with a first operator to one distribution path in the DAS 100, and to configure MU 130 to route digital signals having a PC_ID associated with a second operator to another distribution path in the DAS 100. Additionally, or alternatively, system controller 140 configures MU 130 to route digital signals having a SEQ_ID associated with a first band to a distribution path in the DAS 100, and to configure MU 130 to route digital signals having a SEQ_ID associated with a second band to another distribution path in the DAS 100. In this way, system controller 140 selectively redistributes digital signals from multiple operators and/or from multiple bands supported by DAS 100.

When MU 130 receives a digital signal from baseband entity 103, MU 130 is configured to determine (e.g., by extracting or decoding), an identifier from the digital signal that corresponds to a first operator, such as a PC_ID. MU 130 is also configured to determine (e.g., by extracting or decoding), an identifier from the digital signal that corresponds to a first band, such as a SEQ_ID. Once the MU 130 identifies the PC_ID and/or SEQ_ID, MU 130 is configured to determine which port should be assigned the digital signal based on the PC_ID and/or SEQ_ID. The MU 130 may be configured, from system controller 140, to route the signals associated with the PC_ID and/or SEQ_ID to selected port(s) of a plurality of output ports associated with MU 130. MU 130 then filters the digital signal so that it is output to the port that corresponds to the PC_ID and/or SEQ_ID identified in the digital signal. As MU 130 receives multiple digital signals from baseband entity 103, it can determine the PC_ID and SEQ_ID for each digital signal and selectively route the digital signals to the ports that correspond to each PC_ID and/or SEQ_ID.

In examples where DAS 100 includes multiple MUs 130, each MU 130 can be configured to selectively route only a portion of digital signals that correspond to specific operators and/or bands. In one example, one MU may conventionally process digital signals except signals that include a PC_ID and/or SEQ_ID that correspond to a particular operator and/or band, respectively. For digital signals having those identifiers, MU 130 routes the digital signals to selected ports according to the distribution path determined by system controller 140. A second MU may also conventionally process digital signals except signals with different PC_ID and/or SEQ_IDs, and filter digital signals having those identifiers to their designated ports.

In some examples, ICNs 112A-112B are configured to route digital signals similarly as described for MU 130. That is, ICN 112A is configured to, for a given digital signal, route the digital signal to one or more ports associated with the PC_ID and/or SEQ_ID correlated with the distribution path for that signal. For example, if a SEQ_ID from a digital signal that corresponds to two output ports, ICN 112A routes the digital signal to one of those two output ports.

While digital signals are described as being routed in a downlink direction in the DAS 100 (from the MU 130 ultimately to an RU), in some examples, digital signals can be routed in the uplink direction from signals received from an RU. That is, uplink distribution paths can be defined by the system controller 140 that correspond to each operator and band for an uplink digital signal received from UEs 110, and RUs 106A-106D can route the uplink digital signal based on the operator and band identifier determined from the uplink signal.

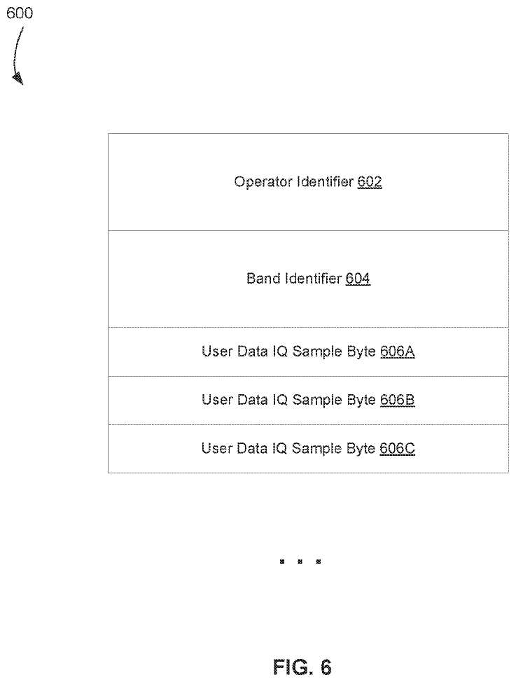

FIG. 6 depicts an exemplary message format of a digital signal transmitted to one or more nodes in a DAS. The digital signal 600 includes an operator identifier 602 that identifies the operator associated with the digital signal 600. In one example, the operator identifier 602 is a PC_ID in a header of an O-RAN data packet. Alternatively, the operator identifier is a PC_ID in a header of an eCPRI data packet. The operator identifier 602 can identify the operator by, for example, a physical channel, a user, a layer, and/or an antenna port, which have a common property for PHY processing. Digital signal 600 also includes a band identifier 604 that identifies the band associated with the digital signal 600. In one example, the band identifier 604 is a SEQ_ID in a header of an O-RAN or eCPRI data packet. The band identifier 604 can identify the band by, for example, an identifier of an orthogonal frequency-division multiplexing (OFDM) symbol, a block of sub-carriers, or other band identifier.

Additionally, digital signal 600 includes one or more data samples carrying the user-plane data. For example, digital signal 600 includes a first byte 606A of the user-data IQ sample, a second byte 606B of the user-data IQ sample, a third byte 606C of the user-data IQ sample, and so on for each byte of user-plane data contained in the digital signal 600.

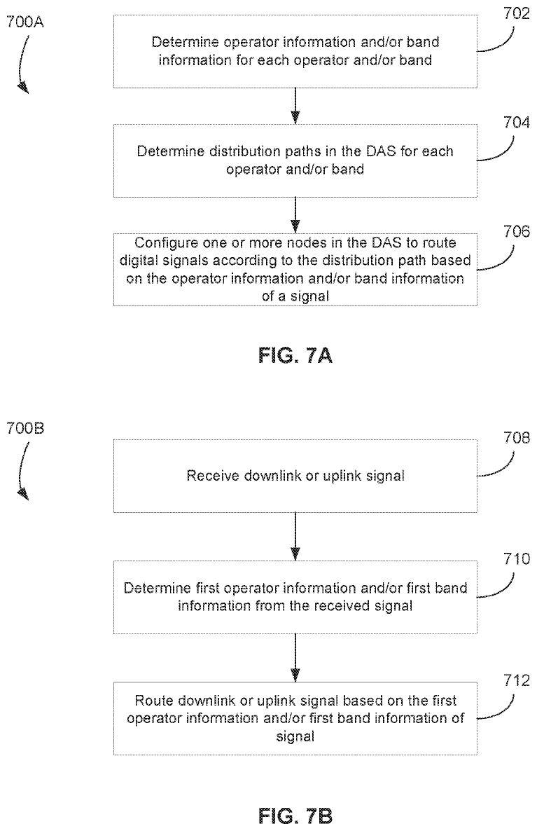

FIGS. 7A-7B depict flow diagrams illustrating exemplary methods for routing downlink DAS signals to one or more nodes of the DAS. FIG. 7A depicts a flow diagram of a method 700A for configuring nodes in a DAS to route digital signals based on different operators and/or bands. FIG. 7B depicts a flow diagram of a method 700B for routing a digital signal based on an identifier corresponding to an operator and/or an identifier corresponding to a band. The blocks of the flow diagrams shown in FIGS. 7A-7B have been arranged in a generally sequential manner for ease of explanation; however, it is to be understood that this arrangement is merely exemplary, and it should be recognized that the processing associated with methods 700A-700B (and the blocks shown in FIGS. 7A-7B) can occur in a different order (for example, where at least some of the processing associated with the blocks is performed in parallel and/or in an event-driven manner). Also, most standard exception handling is not described for ease of explanation; however, it is to be understood that methods 700A-700B can and typically would include such exception handling. One or more aspects of methods 700A-700B can be configurable or adaptive (either manually or in an automated manner). Method 700A can be performed from the perspective of system controller 140 or other management system in the DAS. Method 700B can be performed from the perspective of a master unit, ICN, or other intermediary node of the DAS.

Referring first to FIG. 7A, method 700A includes determining operator information (e.g., an identifier of an operator) and/or band information (e.g., identifier of a band) at block 702. The operator identifier can be a PC_ID and a band identifier can be a SEQ_ID that is present within digital signals received by the DAS from baseband entity 103. The PC_ID corresponds to a particular operator for a plurality of operators utilizing the DAS, and the SEQ_ID corresponds to a particular band for a plurality of bands. At block 704, method 700A includes determining distribution paths in the DAS for each operator and band present in the DAS. The distribution path is a signal pathway through the DAS 100 from the MU to a particular ICN (if the DAS includes ICNs) and/or to a particular RU (RU 106A, for example). A distribution path can be defined as a signal pathway to one or more input/output (I/O) ports of the MU 130 to another node of the DAS 100. A distribution path for one operator may differ from the distribution path for another operator, and a distribution path for one band may differ from the distribution path for another band.

Method 700A also includes configuring one or more nodes in the DAS to route digital signals according to a distribution path based on the operator information and band information of a digital signal at block 706. When system controller 140 determines the distribution paths for each operator and/or band, it can send control signals or M-plane data to one or more nodes in the DAS (e.g., at least one master unit, at least one ICN, and/or at least one other intermediary node such as switch 151 and/or switch 161). The control signals or M-plane data can identify which output ports of the intermediary node correspond to which PC_ID and/or SEQ_ID of a digital signal. In some examples, the system controller 140 or management system can reconfigure the distribution paths in the DAS by updating which PC_ID and/or SEQ_ID correspond to which output ports of a respective node, as operators or bands change in the DAS.

Referring now to method 700B, which includes receiving a downlink or uplink signal at block 708. A downlink signal can be received from at least one base station entity, whereas an uplink signal can be received from one or more RUs. At block 710, method 700B includes determining operator information (e.g., an operator identifier) and/or band information (e.g., a band identifier) of the downlink or uplink signal received at the node. In the downlink direction, a digital signal can be received at the node from a base station entity, such as baseband entity 103, and typically includes user-plane data to be transmitted to user equipment 110. In some examples, the node will extract, decode, or otherwise process the digital signal to identify the indicator of the digital signal that corresponds to the operator and band associated with the received digital signal. In some examples, both the PC_ID (an example of the operator identifier) and SEQ_ID (an example of a band identifier) is determined from a digital signal; however, alternatively, only one of the PC_ID or SEQ_ID is determined in other examples, depending on whether traffic is routed based on different operators or different bands in the DAS.

Method 700B further includes, at block 712, routing the downlink or uplink signal based on the first operator information and/or first band information of the signal. Routing the downlink or uplink signal can include determining one or more output ports corresponding to the operator information and/or the band information identified from the downlink or uplink signal. For example, a master unit or other intermediary node can identify the appropriate output port to route the signal based on the control signals or M-plane data received by system controller 140 that designate which output ports correspond to a particular PC_ID and/or a particular SEQ_ID. In some examples, an output port may correspond to only one operator and/or band. Alternatively, multiple ports may correspond to one operator and/or band.

Method 700B can be repeated for each digital signal received by the intermediary node. In some examples, method 700B is repeated for the same digital signal using a node downstream of the previous node, such as for an ICN that is coupled downstream of the MU in the same distribution path.

The methods and techniques described herein may be implemented in digital electronic circuitry, or with a programmable processor (for example, a special-purpose processor or a general-purpose processor such as a computer) firmware, software, or in various combinations of each. Apparatus embodying these techniques may include appropriate input and output devices, a programmable processor, and a storage medium tangibly embodying program instructions for execution by the programmable processor. A process embodying these techniques may be performed by a programmable processor executing a program product comprising instructions to perform the desired functions by operating on input data and generating appropriate output. The techniques may advantageously be implemented in one or more programs that are executable on a programmable system including at least one programmable processor coupled to receive data and instructions from, and to transmit data and instruction to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), electronically erasable programmable read-only memory (EEPROM), and flash memory devices; magnetic disks such as internal hard disks and removable disks; magneto-optical disks; and digital video disks (DVDs). Any of the foregoing may be supplemented by, or incorporated in, specially-designed application-specific integrated circuits (ASICs).

### EXAMPLE EMBODIMENTS

Example 1 includes a method for distributing signal coverage in a distributed antenna system (DAS), the DAS including at least one master unit communicatively coupled to a plurality of radio units, the plurality of radio units configured to radiate wireless signals to user equipment, the method comprising: receiving a first signal from at least one base station entity; determining first operator information corresponding to a first operator of a plurality of operators from the first signal and/or first band information corresponding to a first band of a plurality of bands from the first signal; routing the first signal to a first radio unit of the plurality of radio units based on the determined first operator information and/or the determined first band information from the first signal.

Example 2 includes the method of Example 1, further comprising: receiving a second signal from the at least one base station entity; determining a second operator information corresponding to a second operator of the plurality of operators different from the first operator from the second signal; and/or a second band information corresponding to a second band of the plurality of bands different from the first band from the second signal; and routing the second signal to a second radio unit of the plurality of radio units different from the first radio unit based on the determined second operator information and/or the determined second band information from the second signal.

Example 3 includes the method of any of Examples 1-2, wherein routing the first signal to a first radio unit of the plurality of radio units based on the determined first operator information and/or the determined first band information comprises routing the first signal based on both the first operator information and the first band information.

Example 4 includes the method of any of Examples 1-3, wherein the first operator information comprises a first operator identifier from the first signal, wherein the first band information comprises a first band identifier from the first signal.

Example 5 includes the method of Example 4, wherein the first signal is a digital signal, wherein the first operator identifier comprises a PC_ID in a header of an Open-Radio Access Network (O-RAN) or enhanced Common Public Radio Interface (eCPRI) data packet, wherein the first band identifier comprises a SEQ_ID in a header of an O-RAN or eCPRI data packet.

Example 6 includes the method of any of Examples 4-5, wherein the first operator identifier includes an identifier of at least one of: a physical channel, a user, a layer, or a port, associated with the first operator.

Example 7 includes the method of any of Examples 4-6, wherein the first band identifier includes an identifier of at least one of: an orthogonal frequency-division multiplexing symbol associated with the first band, or a block of sub-carriers associated with the first band.

Example 8 includes a node of a distributed antenna system (DAS), the DAS including at least one master unit communicatively coupled to a plurality of radio units, the plurality of radio units configured to radiate wireless signals to user equipment comprising: downlink circuitry, wherein the downlink circuitry is configured to: receive a first downlink signal transmitted or derived from at least one base station entity; determine first operator information corresponding to a first operator of a plurality of operators from the first downlink signal and/or first band information corresponding to a first band of a plurality of bands from the first downlink signal; and route the first downlink signal to at least one other node of the distributed antenna system based on the determined first operator information and/or the determined first band information from the first downlink signal.

Example 9 includes the node of Example 8, wherein the node is a master unit of the at least one master unit, wherein the master unit comprises a plurality of output ports, wherein each of the plurality of output ports corresponds to at least one radio unit communicatively coupled to the master unit, wherein the master unit is configured to: determine which of the plurality of output ports correspond to the first operator information from the first downlink signal; and route the first downlink signal to one of the plurality of output ports that corresponds to the first operator information from the first downlink signal.

Example 10 includes the node of any of Examples 8-9, wherein the node is a master unit of the at least one master unit, wherein the master unit comprises a plurality of output ports, wherein each of the plurality of output ports corresponds to at least one radio unit communicatively coupled to the master unit, wherein the master unit is configured: determine which of the plurality of output ports correspond to the first band information from the first downlink signal; and route the first downlink signal to one of the plurality of output ports that corresponds to the first band information from the first downlink signal.

Example 11 includes the node of any of Examples 8-10, wherein the node is an intermediate combining node (ICN) communicatively coupled to the at least one master unit and is communicatively coupled to at least a first radio unit and a second radio unit of the plurality of radio units, wherein the ICN comprises a plurality of output ports, wherein a first output port of the plurality of output ports corresponds to the first radio unit and a second output port of the plurality of output ports corresponds to the second radio unit, wherein the ICN is configured to: receive the first downlink signal from the at least one master unit; and route the first downlink signal to one of the first output port or the second output port that corresponds to the first operator information from the first downlink signal.

Example 12 includes the node of any of Examples 8-11, wherein the node is a switch communicatively coupled to the at least one master unit and is communicatively coupled to at least a first radio unit and a second radio unit of the plurality of radio units, wherein the switch comprises a plurality of output ports, wherein a first output port of the plurality of output ports corresponds to the first radio unit and a second output port of the plurality of output ports corresponds to the second radio unit, wherein the switch is configured: receive the first downlink signal from the at least one master unit; and route the first downlink signal to one of the first output port or the second output port that corresponds to the first band information from the first downlink signal.

Example 13 includes the node of any of Examples 8-12, wherein the first operator information comprises a first operator identifier from the first downlink signal, wherein the first band information comprises a first band identifier from the first downlink signal.

Example 14 includes the node of Example 13, wherein the first downlink signal is a digital signal, wherein the first operator identifier comprises a PC_ID in a header of an Open-Radio Access Network (O-RAN) or enhanced Common Public Radio Interface (eCPRI) data packet, wherein the first band identifier comprises a SEQ_ID in a header of an O-RAN or eCPRI data packet.

Example 15 includes the node of any of Examples 8-14, wherein the first operator information includes an identifier of at least one of: a physical channel, a user, a layer, or a port, associated with the first operator, wherein the first band information includes an identifier of at least one of: an orthogonal frequency-division multiplexing symbol, or a block of sub-carriers, associated with the first band.

Example 16 includes a system, comprising: a distributed antenna system (DAS), comprising: at least one master unit communicatively coupled to at least one base station entity, wherein the at least one master unit is configured to receive downlink signals from the at least one base station entity; a plurality of radio units communicatively coupled to the at least one master unit, wherein each of the plurality of radio units is configured to radiate downlink radio frequency (RF) signals based on the downlink signals to user equipment serviced by the distributed antenna system; and a system controller communicatively coupled to the at least one master unit of the DAS, wherein the system controller is configured to: determine a plurality of operator information and/or a plurality of band information, each respective operator information corresponding to one of a plurality of operators utilizing the distributed antenna system, each respective band information corresponding to one of a plurality of bands; determine, for each respective operator of the plurality of operators and/or each respective band of the plurality of bands, a respective signal distribution path of the DAS; and configure one or more nodes in the DAS to route a received signal having the respective operator information and/or band information according to the respective signal distribution path determined for the respective operator and/or respective band.

Example 17 includes the system of Example 16, wherein the received signal is a digital signal.

Example 18 includes the system of any of Examples 16-17, wherein the at least one master unit is configured to: receive a first downlink signal from the at least one base station entity; determine, from the first downlink signal, first operator information corresponding to a first operator of the plurality of operators from the first downlink signal; and/or first band information corresponding to a first band of a plurality of bands from the first downlink signal; and route the first downlink signal to a first radio unit of the plurality of radio units based on the determined first operator information, and/or the determined first band information from the first downlink signal.

Example 19 includes the system of Example 18, wherein to determine first operator information corresponding to a first operator of a plurality of operators comprises to determine a PC_ID in a header of an Open-Radio Access Network (O-RAN) or enhanced Common Public Radio Interface (eCPRI) data packet corresponding to the first operator; and wherein to determine a first band information corresponding to a first band of a plurality of bands comprises to determine a SEQ_ID in a header of the O-RAN or eCPRI data packet corresponding to the first band.

Example 20 includes the system of any of Examples 18-19, further comprising at least one intermediate combining node (ICN) communicatively coupled to the at least one master unit and to a first radio unit and a second radio unit of the plurality of radio units, wherein the at least one ICN is configured to: receive a first downlink signal from the at least one master unit; and selectively route the first downlink signal to either the first radio unit or the second radio unit based on the first operator information and/or the first band information.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

1. A method for distributing signal coverage in a distributed antenna system (DAS), the DAS including at least one master unit communicatively coupled to a plurality of radio units, the plurality of radio units configured to radiate wireless signals to user equipment, the method comprising:
receiving a first signal from at least one base station entity;
determining at least one of first operator information corresponding to a first operator of a plurality of operators from the first signal or first band information corresponding to a first band of a plurality of bands from the first signal; and
routing the first signal to a first radio unit of the plurality of radio units based on the at least one of the first operator information or the first band information from the first signal.

2. The method of claim 1, further comprising:
receiving a second signal from the at least one base station entity;
determining at least one of second operator information corresponding to a second operator of the plurality of operators different from the first operator from the second signal or second band information corresponding to a second band of the plurality of bands different from the first band from the second signal; and
routing the second signal to a second radio unit of the plurality of radio units different from the first radio unit based on the at least one of the second operator information or the second band information from the second signal.

3. The method of claim 1, wherein routing the first signal to the first radio unit of the plurality of radio units based on the at least one of the first operator information or the first band information comprises routing the first signal based on both the first operator information and the first band information.

4. The method of claim 1, wherein the first operator information comprises a first operator identifier from the first signal, wherein the first band information comprises a first band identifier from the first signal.

5. The method of claim 4, wherein the first signal is a digital signal, wherein the first operator identifier comprises a PC_ID in a header of at least one of an Open-Radio Access Network (O-RAN) or enhanced Common Public Radio Interface (eCPRI) data packet, wherein the first band identifier comprises a SEQ_ID in the header of the at least one of the O-RAN or eCPRI data packet.

6. The method of claim 4, wherein the first operator identifier includes an identifier of at least one of: a physical channel, a user, a layer, or a port, associated with the first operator.

7. The method of claim 4, wherein the first band identifier includes an identifier of at least one of: an orthogonal frequency-division multiplexing symbol associated with the first band, or a block of sub-carriers associated with the first band.

8. A node of a distributed antenna system (DAS), the DAS including at least one master unit communicatively coupled to a plurality of radio units, the plurality of radio units configured to radiate wireless signals to user equipment comprising:
downlink circuitry, wherein the downlink circuitry is configured to:
receive a first downlink signal transmitted or derived from at least one base station entity;
determine at least one of first operator information corresponding to a first operator of a plurality of operators from the first downlink signal or first band information corresponding to a first band of a plurality of bands from the first downlink signal; and
route the first downlink signal to at least one other node of the distributed antenna system based on the at least one of the first operator information or the first band information from the first downlink signal.

9. The node of claim 8, wherein the node is a master unit of the at least one master unit, wherein the master unit comprises a plurality of output ports, wherein each of the plurality of output ports corresponds to at least one radio unit communicatively coupled to the master unit, wherein the master unit is configured to:
determine which of the plurality of output ports correspond to the first operator information from the first downlink signal; and
route the first downlink signal to one of the plurality of output ports that corresponds to the first operator information from the first downlink signal.

10. The node of claim 8, wherein the node is a master unit of the at least one master unit, wherein the master unit comprises a plurality of output ports, wherein each of the plurality of output ports corresponds to at least one radio unit communicatively coupled to the master unit, wherein the master unit is configured to:
determine which of the plurality of output ports correspond to the first band information from the first downlink signal; and
route the first downlink signal to one of the plurality of output ports that corresponds to the first band information from the first downlink signal.

11. The node of claim 8, wherein the node is an intermediate combining node (ICN) communicatively coupled to the at least one master unit and is communicatively coupled to at least a first radio unit and a second radio unit of the plurality of radio units, wherein the ICN comprises a plurality of output ports, wherein a first output port of the plurality of output ports corresponds to the first radio unit and a second output port of the plurality of output ports corresponds to the second radio unit, wherein the ICN is configured to:
receive the first downlink signal from the at least one master unit; and
route the first downlink signal to one of the first output port or the second output port that corresponds to the first operator information from the first downlink signal.

12. The node of claim 8, wherein the node is a switch communicatively coupled to the at least one master unit and is communicatively coupled to at least a first radio unit and a second radio unit of the plurality of radio units, wherein the switch comprises a plurality of output ports, wherein a first output port of the plurality of output ports corresponds to the first radio unit and a second output port of the plurality of output ports corresponds to the second radio unit, wherein the switch is configured to:
receive the first downlink signal from the at least one master unit; and
route the first downlink signal to one of the first output port or the second output port that corresponds to the first band information from the first downlink signal.

13. The node of claim 8, wherein the first operator information comprises a first operator identifier from the first downlink signal, wherein the first band information comprises a first band identifier from the first downlink signal.

14. The node of claim 13, wherein the first downlink signal is a digital signal, wherein the first operator identifier comprises a PC_ID in a header of at least one of an Open-Radio Access Network (O-RAN) or enhanced Common Public Radio Interface (eCPRI) data packet, wherein the first band identifier comprises a SEQ_ID in the header of the at least one of the O-RAN or eCPRI data packet.

15. The node of claim 8, wherein the first operator information includes an identifier of at least one of: a physical channel, a user, a layer, or a port, associated with the first operator, wherein the first band information includes an identifier of at least one of: an orthogonal frequency-division multiplexing symbol, or a block of sub-carriers, associated with the first band.

16. A system, comprising:
a distributed antenna system (DAS), comprising:
at least one master unit communicatively coupled to at least one base station entity, wherein the at least one master unit is configured to receive downlink signals from the at least one base station entity;
a plurality of radio units communicatively coupled to the at least one master unit, wherein each of the plurality of radio units is configured to radiate downlink radio frequency (RF) signals based on the downlink signals to user equipment serviced by the distributed antenna system; and
a system controller communicatively coupled to the at least one master unit of the DAS, wherein the system controller is configured to:
determine at least one of a plurality of operator information or a plurality of band information, each respective operator information corresponding to one of a plurality of operators utilizing the distributed antenna system, each respective band information corresponding to one of a plurality of bands;
determine, for at least one of each respective operator of the plurality of operators or each respective band of the plurality of bands, a respective signal distribution path of the DAS; and
configure one or more nodes in the DAS to route a received signal having at least one of the respective operator information or band information according to the respective signal distribution path determined for at least one of the respective operator or the respective band.

17. The system of claim 16, wherein the received signal is a digital signal.

18. The system of claim 16, wherein the at least one master unit is configured to:
receive a first downlink signal from the at least one base station entity;
determine, from the first downlink signal, at least one of first operator information corresponding to a first operator of the plurality of operators from the first downlink signal or first band information corresponding to a first band of the plurality of bands from the first downlink signal; and
route the first downlink signal to a first radio unit of the plurality of radio units based on the at least one of the first operator information or the first band information from the first downlink signal.

19. The system of claim 18, wherein to determine the first operator information corresponding to the first operator of the plurality of operators comprises to determine a PC_ID in a header of an Open-Radio Access Network (O-RAN) or enhanced Common Public Radio Interface (eCPRI) data packet corresponding to the first operator; and wherein to determine the first band information corresponding to the first band of the plurality of bands comprises to determine a SEQ_ID in the header of the O-RAN or eCPRI data packet corresponding to the first band.

20. The system of claim 18, further comprising at least one intermediate combining node (ICN) communicatively coupled to the at least one master unit and to the first radio unit and a second radio unit of the plurality of radio units, wherein the at least one ICN is configured to:
receive a second downlink signal from the at least one master unit; and
selectively route the second downlink signal to either the first radio unit or the second radio unit based on the at least one of the first operator information or the first band information.
